(19) United States
(12) Patent Application Publication
(10) Pub. No.: US 2018/0176493 A1
(43) Pub. Date: Jun. 21, 2018

(54) IMAGE SENSOR CIRCUITS AND METHODS

(71) Applicant: UTI LIMITED PARTNERSHIP, Calgary (CA)

(72) Inventors: Artur Spivak, Calgary (CA); Orly Yadid-Pecht, Calgary (CA)

(73) Assignee: UTI LIMITED PARTNERSHIP, Calgary, AB (CA)

(21) Appl. No.: 15/578,940

(22) PCT Filed: Jun. 2, 2016
(86) PCT No.: PCT/CA2016/000162

§ 371 Date: Dec. 1, 2017

Related U.S. Application Data
(60) Provisional application No. 62/230,265, filed on Jun. 2, 2015.

(51) Int. Cl. H04N 5/363; H04N 5/378; H04N 5/3745

(52) U.S. Cl. CPC H04N 5/363; H04N 5/3745; H04N 5/378

(57) ABSTRACT

A control circuit for an image sensor includes an active reset control circuit configured to perform an active reset of a light flux-dependent node (such as a photodetector) of a pixel of the image sensor using an amplifier which is also used for readout of the photodetector. The control circuit further includes a readout control circuit configured to maintain a readout configuration of the amplifier during the active reset.

### CROSS-REFERENCE TO RELATED APPLICATIONS

This application claims the benefit of priority from U.S. Patent Application No. 62/230,265 filed on Jun. 2, 2015, which is hereby incorporated herein by reference.

### FIELD OF THE INVENTION

The present invention relates to image sensors. More particularly, illustrative embodiments relate to image sensor circuits and methods for controlling image sensors.

### BACKGROUND OF THE INVENTION

Many technology areas benefit from high-sensitivity image sensors. For example, Complementary Metal Oxide Semiconductor (CMOS) image sensors are often used in biomedical, biomechanical or other biological applications, to provide very sensitive high-speed optical signal detection at relatively low cost and with relatively low power consumption. High sensitivity is important for many such applications, such as discerning between different biological tissues under low light illumination, for example.

The sensitivity of a sensor can be affected by a number of factors. One relevant factor is the sensor's measurement noise: lower measurement noise permits an acceptable signal-to-noise ratio to be obtained at lower signal strengths, thereby extending the dynamic range of the sensor to include such lower signal strengths. Another relevant factor is the so-called fill factor (“FF”), meaning the percentage of the surface area of each pixel that is photosensitive: increasing the number of active circuitry components within each pixel tends to leave less room for the photodetector itself, thereby reducing the fill factor. Historically there has been a trade-off between these two factors, with solutions that reduce noise tending to also increase the number of active circuitry components and thereby reduce the fill factor.

For example, reset noise is significant in CMOS image sensors. In this regard, to prevent image lag, whereby traces of a previous image frame remain in future image frames, it is necessary to reset each photodetector of each pixel between successive frame measurements. Some early CMOS sensors prevented image lag by employing a hard reset, which resulted in thermal noise (Johnson noise) on the photodetector, referred to in the art as “kTC noise” for its magnitude on the order of kT/C, where k is Boltzmann's constant, T is temperature and C is capacitance. Numerous other reset methods have been proposed, including the more modern active reset method, in which the photosensing node of the pixel is driven by an opamp to compensate for the KTC noise fluctuations. Active reset methods have achieved some success in reducing such reset noise, but their complexity has required additional circuitry, either within each pixel or in the column-wise circuitry or both, including circuitry for switching between a readout configuration and a reset configuration (a switching process which may itself generate additional noise). Consequently, active reset methods have thus far presented somewhat of a compromise, incurring disadvantages such as larger pixel size, smaller fill factor, or added manufacturing complexity and costs, in exchange for the advantage of an overall reduction in reset noise.

### SUMMARY

In one illustrative embodiment, a method of controlling an image sensor includes performing an active reset of a light flux-dependent node of a pixel of the image sensor using an amplifier which is also used for readout of the light flux-dependent node. The method further includes maintaining a readout configuration of the amplifier during the active reset. The light flux-dependent node may include a photodetector such as a photodiode, for example, or other pixel node whose measurable quantity (e.g. voltage) depends upon the amount of light flux incident upon the pixel.

Advantageously, by using the same amplifier for both readout and active reset of the photodetector (or other light flux-dependent node), and by maintaining that amplifier in its readout configuration during the active reset, the conventional switching between readout and reset configurations may be avoided. Consequently, both in-pixel circuitry and column-wise circuitry may be simplified.

Each pixel, for example, may omit separate access transistors that would have otherwise been in communication with the reset transistor, and indeed, in some embodiments only a single reset transistor may be used to control the active reset. Advantageously, therefore, with fewer required in-pixel transistors, each pixel's size may be reduced, or its fill factor may be increased, or both, and in either case its manufacturing complexity and cost may be lowered.

In the column-wise shared circuitry, logic previously used for switching between readout and reset configurations may be omitted, thereby tending to further lower manufacturing complexity and cost.

Advantageously, noise associated with switching between readout and reset configurations may be avoided, and overall noise may be reduced. Consequently, unlike conventional active reset methods, illustrative embodiments of the present specification may tend to defy the conventional trade-off between noise and complexity, by providing reductions in both.

Moreover, advantageous effects such as those discussed above may also co-operatively contribute to the further advantage of a wider dynamic range, permitting lower signal strengths to be measured with acceptable signal-to-noise ratios. The advantageous reduction in reset noise may reduce the denominator (noise) of the signal-to-noise ratio, while the advantageous ability to increase the fill factor of each pixel may increase the numerator (signal strength) of this ratio. Thus, these two different effects may co-operate to further increase the sensitivity and dynamic range of the resulting image sensor.

Performing the active reset may include placing the light flux-dependent node in electrical communication with an internal node of the amplifier to form a negative feedback to the light flux-dependent node. The light flux-dependent node may include a photodetector, and placing the photodetector in electrical communication with the amplifier's internal node may include shorting the photodetector across first and second load lines of the amplifier.

The method may further include maintaining the readout configuration while performing a readout of the pixel.

Maintaining the readout configuration may include maintaining a unity gain configuration of the amplifier. Maintaining the unity gain configuration may include maintaining an output of the amplifier in electrical communication with a gate terminal of a switching element, wherein the switching element has a source terminal in electrical communication with a current source load line of the amplifier.

Maintaining the readout configuration may include maintaining the readout configuration of an amplifier located at least partly outside the pixel within the pixel. Alternatively, maintaining the readout configuration may include maintaining the readout configuration of an amplifier located inside the pixel.

In another illustrative embodiment, a control circuit for an image sensor includes an active reset control circuit configured to perform an active reset of a light flux-dependent node of a pixel of the image sensor using an amplifier which is also used for readout of the light flux-dependent node. The control circuit further includes a readout control circuit configured to maintain a readout configuration of the amplifier during the active reset. Advantages similar to those of the method described above may be obtained using such a control circuit.

The active reset control circuit may include a switching element configured to place the light flux-dependent node in electrical communication with an internal node of the amplifier to form a negative feedback to the light flux-dependent node. For example, the light flux-dependent node may include a photodetector, and the active reset control circuit may include an asymmetrical active reset control circuit configured to short the photodetector across first and second load lines of the amplifier.

The readout control circuit may be further configured to maintain the readout configuration while performing a readout of the pixel.

The readout control circuit may be configured to maintain the readout configuration by maintaining a unity gain configuration of the amplifier. The readout control circuit may be configured to maintain an output of the amplifier in electrical communication with a gate terminal of a switching element, wherein the switching element has a source terminal in electrical communication with a current source load of the amplifier.

The readout control circuit may include a differential pair of transistors, wherein one of the differential pair includes the switching element, and wherein the other of the differential pair has a gate terminal in electrical communication with the light flux-dependent node and has a channel terminal in electrical communication with a second load line of the amplifier.

The readout control circuit may further include a readout transistor having a first channel terminal in communication with channel terminals of the differential pair and having a second channel terminal in communication with a shared source line.

The readout control circuit may include: a first transistor having a gate terminal in electrical communication with the light flux-dependent node and having a first channel terminal in electrical communication with a load line of the amplifier; and a readout transistor configured to conduct between a second channel terminal of the first transistor and a sink line of the amplifier in response to a readout signal received at a gate terminal of the readout transistor.

The light flux-dependent node may include a photodetector and the active reset control circuit may include a reset transistor configured to place the photodetector in simultaneous electrical communication with a sink line and a load line of the amplifier.

The control circuit may further include the amplifier, which may be located at least partly outside the pixel. The amplifier may include a folded cascode amplifier, for example. Alternatively, the amplifier may be located within the pixel.

In another illustrative embodiment, an image sensor pixel includes a control circuit as described herein and includes no more than four transistors. In another illustrative embodiment, an image sensor pixel includes a control circuit as described herein and includes no more than three transistors.

In another illustrative embodiment, a Complementary Metal Oxide Semiconductor (CMOS) image sensor includes a plurality of pixels, each of the pixels including a control circuit as described herein.

Other aspects, features and advantages of illustrative embodiments of the present invention will become apparent to those ordinarily skilled in the art upon review of the following description of such embodiments in conjunction with the accompanying figures.

### BRIEF DESCRIPTION OF THE DRAWINGS

In drawings which illustrate embodiments of the invention,

FIG. 1 is a circuit diagram of an image sensor pixel according to a first embodiment of the invention;

FIG. 2 is a circuit diagram of an image sensor incorporating a plurality of pixels identical to those of FIG. 1;

FIG. 3 is a circuit diagram of a unity gain amplification (UGA) readout circuit of the image sensor of FIG. 2;

FIG. 4 is a circuit diagram of a column charge amplifier of the image sensor of FIG. 2;

FIG. 5 is a circuit diagram of a column high-precision comparator of a single-slope analog-to-digital converter of the image sensor of FIG. 2;

FIG. 6 is a circuit diagram of a digital register circuit of the single-slope analog-to-digital converter of the image sensor of FIG. 2;

FIG. 7 is a circuit layout of the pixel of FIG. 1;

FIG. 8 is a graphical representation of noise attenuation during a simulated asymmetrical active reset of the pixel of FIG. 1;

FIG. 9 is a circuit diagram of an image sensor pixel according to a second embodiment of the invention;

FIG. 10 is a circuit diagram of a unity gain amplification (UGA) readout circuit of the image sensor of FIG. 2, modified for use with the pixel of FIG. 9;

FIG. 11 is a circuit diagram of a single ended open loop amplification configuration for the pixel of FIG. 1;

FIG. 12 is a circuit diagram of a single ended open loop amplification configuration for the pixel of FIG. 9;

FIG. 13 is a circuit diagram of the pixel of FIG. 9 in conjunction with a two-stage amplifier; and

FIGS. 14 and 15 depict Wide Dynamic Range (WDR) configurations of the pixel of FIG. 1, without ranging and with ranging, respectively.

### DETAILED DESCRIPTION

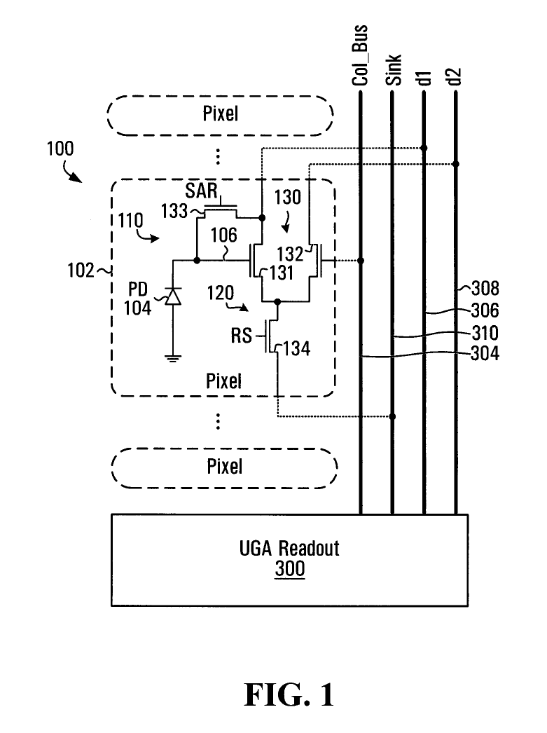

Referring to FIGS. 1-3, a control circuit for an image sensor according to a first embodiment of the invention is shown generally at 100. In this embodiment, the control circuit 100 includes an active reset control circuit 110 configured to perform an active reset of a light flux-dependent node of a pixel 102 of the image sensor using an amplifier 302 which is also used for readout of the light flux-dependent node. In this embodiment, the control circuit 100 further includes a readout control circuit 120 configured to maintain a readout configuration of the amplifier 302 during the active reset. In this embodiment, the readout control circuit 120 is also configured to maintain the same readout configuration while performing a readout of the pixel. Also in this embodiment, the light flux-dependent node includes a photodetector 104, as discussed below. The active reset control circuit 110 and readout control circuit 120 are discussed in greater detail below in the course of elaborating upon the pixel 102 and its operation.

### Image Sensor

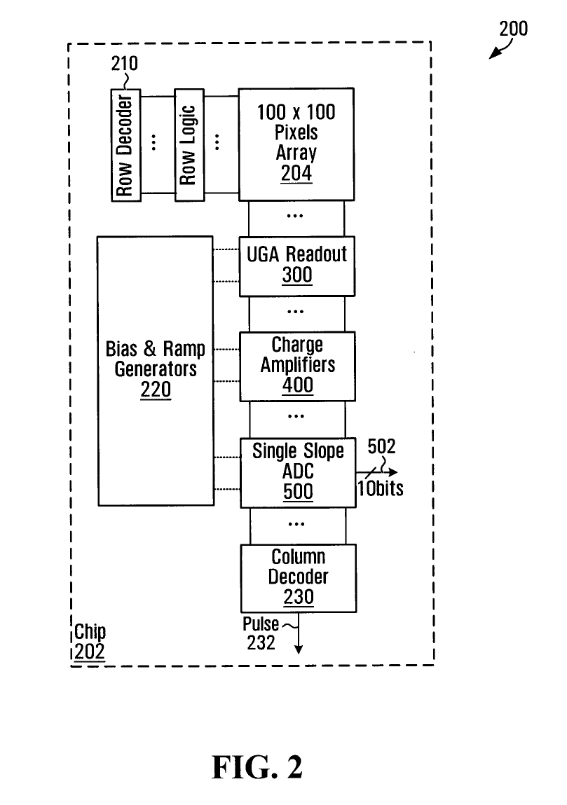

Referring to FIGS. 1-3, an image sensor including the control circuit 100 is shown generally at 200 in FIG. 2. In this embodiment, the image sensor 200 includes a Complementary Metal Oxide Semiconductor (CMOS) image sensor. More particularly, in this embodiment the CMOS image sensor is embodied in a chip 202 which includes a plurality of pixels, each of the pixels being identical to the pixel 102 shown in FIG. 1 and thus including the control circuit 100. More particularly still, in this embodiment the image sensor 200 includes a pixels array 204 having 100 rows×100 columns of pixels, with each of the 10,000 pixels being identical to the pixel 102. Alternatively, other sizes of pixel arrays may be substituted.

In this embodiment, the pixels of the array 204 are controlled via a Row Decoder and Row Logic block 210. In this embodiment, pixel control signals are input to the Row Logic, where they are leveled up and delivered to each of the pixel row drivers. In this embodiment, the current command is AND-ed with a row address from the Row Decoder, in order to assert the desired operation to the selected pixel row. In this embodiment, only two control lines are used to control the pixels array 204, one line for active reset and the other line for readout.

In this embodiment, the image sensor 200 further includes a readout block 300 and a column charge amplifiers block 400. More particularly, in this embodiment the readout block 300 includes a Unity Gain Amplification (UGA) readout block in communication with the pixels array 204, through which the pixel levels of the various pixels are sampled. The column charge amplifiers block 400 then amplifies the pixel signals according to a selected gain level.

In this embodiment, the image sensor 200 further includes an analog-to-digital conversion (ADC) block 500. More particularly, in this embodiment the ADC block 500 includes a single slope (SS) ADC block with 10-bit resolution, which performs the analog-to-digital conversion in parallel for all pixels within a given row, and which sequentially scans digitized outputs via an out bus 502.

Also in this embodiment, the image sensor 200 includes a bias & ramp generators block 220, which provides the required DC voltages and climbing ramp (reference signal) for the readout block 300, the charge amplifiers block 400 and the ADC block 500. In the present embodiment, the digital control voltages and analog bias voltages are generated off the chip 202 and relayed to the required on-chip components by the bias & ramp generators block 220. Alternatively, the bias & ramp generators block 220 may include an Application Specific Integrated Circuit (ASIC) configured with control code to generate all required control signals, reference signals and biases from on-board the chip 202.

The image sensor 200 of the present embodiment further includes a column decoder block 230, which multiplexes the ADC triggering signals to a single output line 232.

### Pixel

Referring to FIG. 1, an illustrative one of the 10,000 pixels of the pixels array 204 is shown at 102. In this embodiment, the pixel 102 includes the control circuit 100, and the pixel 102 includes no more than four transistors. More particularly, as discussed below, in this embodiment the pixel 102 has exactly four transistors.

In this embodiment, the light flux-dependent node of the pixel 102 includes the photodetector 104, which detects electromagnetic radiation (light) via the photoelectric effect, whereby photons interacting with a photoelectric material such as crystallized silicon cause electrons to jump from the valence band to the conduction band. More particularly, in this embodiment the photodetector 104 is a photodiode. Alternatively, PIN photodiodes, other suitable photodiodes or more generally other photodetectors may be substituted. In some such embodiments, it is not the photodetector 104 itself whose signal is to be actively reset to prevent image lag, but rather, a related pixel node such as a sampling node. Thus, in other embodiments, the light flux-dependent node of the pixel, which is to be actively reset, may generally include other pixel nodes whose measurable property (e.g. voltage) depends upon the light flux incident upon the pixel.

In this embodiment, the readout control circuit 120 includes a differential pair 130, which includes first and second differential pair transistors 131 and 132.

In this embodiment, each of the transistors 131 and 132 is a field-effect transistor having two channel terminals (source and drain) and a gate terminal for controlling the flow of electrical current between the source and drain terminals. More particularly, in this embodiment the first and second transistors 131 and 132 are NMOS transistors.

In this embodiment, the readout control circuit 120 further includes a readout transistor 134 having a first channel terminal in communication with channel terminals of the differential pair 130, and having a second channel terminal in communication with a shared source line. In this regard, a photosensing node 106 at the same potential as the photodetector 104 is in electrical communication with a gate terminal of the transistor 131. The first channel terminal of the transistor 131 is in electrical communication with a first load line 306 of the amplifier 302, which in turn is connected to a drain terminal of a first current source transistor 331 of the amplifier 302. The second channel terminal of the transistor 131 is in simultaneous electrical communication with the first channel terminal of the readout transistor 134 (which in this embodiment includes an NMOS transistor) and with the first channel terminal of the second differential pair transistor 132, respectively. In the present embodiment, the second channel terminal of the readout transistor 134 is in electrical communication with a shared source line or sink line 310 of the readout block 300, and the gate terminal of the readout transistor 134 is in communication with a readout signal (RS) line, one of only two digital control lines used to control the pixel array 204 in the present embodiment. The second channel terminal of the second differential pair transistor 132 is in electrical communication with a second load line 308 of the amplifier 302, which in turn is connected to a drain terminal of a second current source transistor 332 of the amplifier 302. In this embodiment, to form a Unity Gain Amplification (UGA) configuration, the gate terminal of the second differential pair transistor 132 is connected to an output line 304 of the amplifier 302 of the readout block 300, which in this embodiment includes a column bus line.

In this embodiment, the photodetector 104 and photosensing node 106 are in electrical communication with a first channel terminal of a reset transistor 133, which in this embodiment includes an NMOS transistor. A second channel terminal of the reset transistor 133 is in electrical communication with the first load line 306 of the amplifier 302. A gate terminal of the reset transistor 133 is in electrical communication with an active reset (SAR) line, which is the other one of the two digital control lines used to control the pixel array 204 in the present embodiment.

As discussed in greater detail below, in this embodiment, sensing or readout of the pixel includes pulsing the RS line to high, thereby causing the readout transistor 134 to temporarily connect the second load line 308 to the shared source or sink line 310.

In this embodiment, the active reset control circuit 110 includes a switching element configured to place the light flux-dependent node in electrical communication with an internal node of the amplifier 302 to form a negative feedback to the light flux-dependent node. More particularly, in this embodiment the light flux-dependent node of the pixel 102 includes the photodetector 104, and the switching element is configured to place the photodetector 104 in simultaneous electrical communication with first and second lines of the amplifier 302. To achieve this, in the present embodiment the active reset control circuit 110 includes an asymmetrical active reset control circuit configured to short the photodetector 104 across first and second load lines 306 and 308 of the amplifier 302. More particularly, in this embodiment the asymmetrical active reset control circuit includes the reset transistor 133 to temporarily place the photodetector 104 and photosensing node 106 in simultaneous electrical communication with both the first load line 306 and the second load line 308 of the amplifier 302. As the load lines 306 and 308 of the amplifier 302 are not symmetrical relative to the in-pixel differential pair 130, the present inventors have referred to this new type of active reset as an “asymmetrical” active reset, as discussed in the Operation section below. Also advantageously, in this embodiment the readout configuration of the pixel 102, with the readout transistor 134 conducting between its channel terminals, may be maintained throughout the active reset process.

### Readout Block

Referring to FIGS. 1-3, generally in this embodiment the readout block 300 obtains the analog levels of the various pixels of the array 204 using Active Column Sensing (ACS).

In this embodiment, the control circuit 100, or more particularly the active reset control circuit 110, includes the amplifier 302 of the readout block 300. More particularly, in this embodiment the amplifier 302 is located at least partly outside the pixel 102, and includes a folded cascode operational amplifier (opamp). As noted above, the differential pair transistors 131 and 132 inside each pixel 102 are connected to the drain terminals of first and second current source transistors 331 and 332 of the folded cascode amplifier, which in this embodiment are biased by a first bias line 320 in communication with their gate terminals and with an external bias voltage.

In this embodiment, the amplifier 302 further includes a separator circuit 350, configured to separate the load from the rest of the amplifier 302, to boost output impedance, and to reduce undesirable charge injections onto the load lines 306 and 308. More particularly, in this embodiment the separator circuit 350 includes first and second cascode transistors 333 and 334, which in this embodiment are biased by a second bias line 322 in communication with their gate terminals and with an external bias voltage.

As noted above, the output line 304 of the amplifier 302, which in this embodiment is the column bus line, is connected to the gate terminal of the second differential pair transistor 132 of each pixel 102, thus forming a unity gain amplification (UGA) configuration.

In the present embodiment, the amplifier 302 further includes biased transistors 337 and 339, and load transistors 338 and 340. In this embodiment, the biased transistors 337 and 339 are diode-connected and hence self-biased, and provide the driving voltages for the load transistors 338 and 340.

In this embodiment, the amplifier 302 further includes a stability compensation circuit 360. In this regard, as is known in the art, a unity gain operational amplifier generally requires a sufficient phase margin (PM) to maintain stability, particularly if the opamp is to be used in closed loop or negative feedback configurations. Accordingly, in this embodiment the stability compensation circuit 360 includes a lead compensation circuit, which more particularly includes a metal oxide semiconductor (MOS) resistor 335 and a Miller metal-insulator-metal (MIM) capacitor 336. The MOS resistor 335 has a voltage-dependent resistance, which more particularly is a function of its strength, threshold voltage and gate source voltage drop. In this embodiment, the source and gate voltages of the MOS resistor 335 are derived from the source and gate terminals of the diode-connected, self-biased transistor 337, so that the overdrive voltage (gate source voltage drop minus threshold voltage) of the MOS resistor 335 equals that of the transistor 337, thereby ensuring a close match between the trans-conductance of the transistor 337 and the resistance of the MOS resistor 335. Advantageously, therefore, in this embodiment the amplifier 302 achieves a remarkable phase margin (PM) without the need for external biasing of the MOS resistor 335.

In this embodiment, the amplifier 302 further includes a current source 370, which in this embodiment is configured to provide noise immunity for active column sensing. More particularly, in this embodiment the current source 370 includes a cascoded current source, implemented by transistors 341 and 342. In this embodiment, the cascoded current source 370 sinks, through the Sink line 310, the tail currents from the in-pixel differential pair transistors 131 and 132. A bias line (Bias_N) 343 sets the current through the transistor 342, and a boost line (Cas_N) 344 sets the resistance boost of the transistor 341. When a certain pixel has to be read out, the gate of the in-pixel readout transistor 134 is pulsed high, connecting the pixel source to the Sink line 310, thus activating the folded cascode structure. After a short settling time, the pixel output appears on the output (Col_Bus) line 304 of the readout block 300, through which it is wired to the charge amplifiers block 400, where it is boosted before the ND conversion.

In this embodiment, the transistors 331, 332, 333 and 334 are PMOS transistors, the MOS resistor 335 includes an NMOS transistor, and the transistors 337 to 342 are NMOS transistors.

### Charge Amplifiers

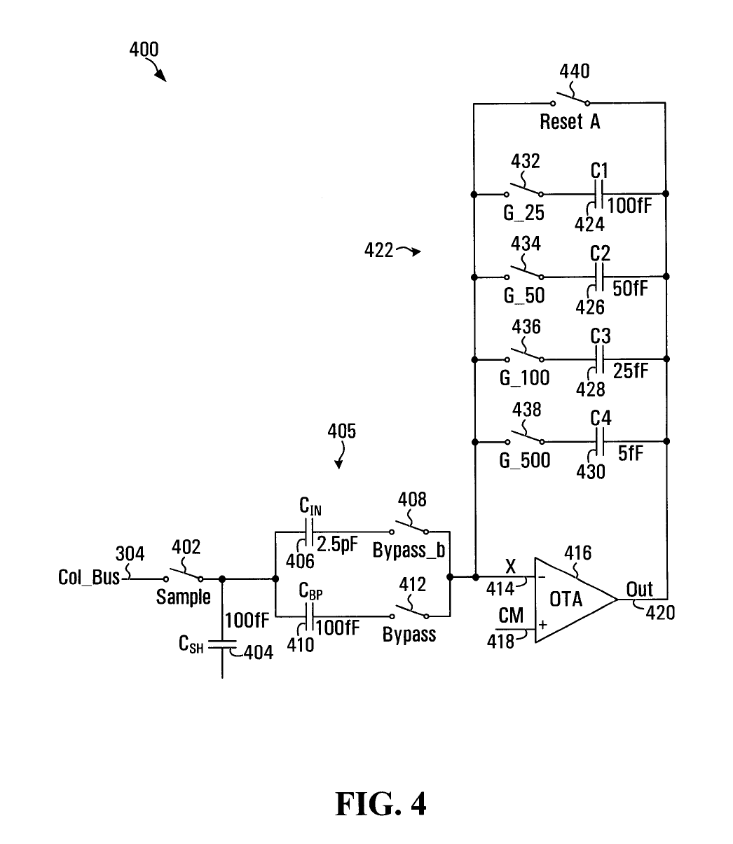

Referring to FIGS. 2 and 4, the charge amplifiers block is shown generally at 400 in FIG. 4. In this embodiment, the amplifier output line 304 of the readout block 300 is connected through a sample switch 402 to a first plate of a capacitor 404. In this embodiment, the capacitor 404 has a capacitance of 100 fF, and a second plate of the capacitor 404 is grounded. Generally, in this embodiment the capacitor 404 and other capacitors of the charge amplifiers block 400 are Metal-Insulator-Metal (MIM) capacitors.

In this embodiment, the first plate of the capacitor 404 is connected to a first selector circuit shown generally at 405, which in this embodiment includes a main sampling capacitor 406, a first switch 408, a bypass sampling capacitor 410 and a second switch 412. In this embodiment, the main sampling capacitor 406 has a capacitance of 2.5 pF, while the bypass sampling capacitor has a capacitance of 100 fF.

In the present embodiment, an output node 414 of the first selector circuit 405 is connected to an amplifier, which in this embodiment includes an operational transconductance amplifier (OTA) 416. More particularly, in this embodiment the output node 414 of the first selector circuit 405 is connected to the inverting (−) input of the OTA 416, while a non-inverting (+) input 418 of the OTA 416 is connected to a common mode (CM) or reference line.

In this embodiment, an output line 420 of the OTA 416 is in electrical communication with a second selector circuit 422. In this embodiment, the second selector circuit 422 includes four different feedback capacitors 424, 426, 428 and 430, selectable through actuation of respective switches 432, 434, 436 and 438. In this embodiment, the capacitances of the feedback capacitors 424, 426, 428 and 430 are 100 fF, 50 fF, 25 fF and 5 fF, respectively, and the switches 432, 434, 436 and 438 are actuatable by raising or lowering corresponding independent gate terminal gain signals G_25, G_50, G_100 and G_500.

In this embodiment, to achieve gain values greater than unity, a Bypass signal is kept low to maintain the second switch 412 in an open (non-conducting) state, while a Bypass_b signal is set high to close the first switch 408, thereby connecting the pixel's column bus output signals on the readout block's output line 304 to the main sampling capacitor 406. One of the gain signals G_25, G_50, G_100 or G_500 is raised, in order to select a respective gain level of 25, 50, 100 or 500, corresponding to a respective one of the feedback capacitors 424, 426, 428 and 430.

Alternatively, if a unity gain is desired, the Bypass and Bypass_b signals may be inverted, to open the first switch 408 and close the second switch 412, thereby connecting the pixel's column bus output signals on the readout block's output line 304 to the bypass sampling capacitor 410. In this embodiment, the capacitance of the bypass sampling capacitor 410 is only 100 fF, or 1/25^{th} that of the main sampling capacitor 406. Accordingly, to achieve unity gain, the G_25 signal is set high while the G_50, G_100 and G_500 signals are kept low, thereby selecting a gain of 25 corresponding to the feedback capacitor 424. The selected 25× gain offsets the 25× reduction that resulted from substituting the bypass sampling capacitor 410 for the main sampling capacitor 406, resulting in a gain of 1.

As a further alternative, if desired, all of the feedback switches may be simultaneously activated, resulting in a gain of 0.5, which may be suitable for some wide dynamic range (WDR) capture applications. More particularly, in this embodiment a gain of 0.5 may be achieved by: setting the Bypass signal high to close the switch 412 to select the bypass sampling capacitor 410; setting the Bypass_b signal low to open the switch 408 to thereby de-select and bypass the main sampling capacitor 406; setting the Reset_A signal low to open the switch 440 and setting all of the G_25, G_50, G_100 and G_500 signals high to close all of the gain switches 432, 434, 436 and 438 to simultaneously select all four of the feedback capacitors 424, 426, 428 and 430.

In this embodiment, the charge amplifiers block 400 further includes a reset switch 440 for resetting the charge amplifier, as discussed in greater detail below.

Thus, the present embodiment employs single phase amplification, i.e., amplification in which the charge integration and charge transfer occur concurrently, rather than two-phase amplification, in which the charge integration and transfer are separate operations. Two-phase amplification typically requires additional switching hardware to switch the positive sampling capacitance terminal between the input and the common mode or reference level CM, which may also decrease the signal integrity. Advantageously, therefore, the present embodiment avoids these difficulties. Alternatively, however, other embodiments may employ two-phase charge amplifiers, or more generally other types of charge amplifiers.

### Analog-to-Digital Conversion

Referring to FIGS. 2, 5 and 6, the ADC block is shown generally at 500. In this embodiment, the ADC block 500 includes a comparator circuit shown generally at 510, and a register circuit shown generally at 600.

For the comparator to have sufficient gain and speed, in this embodiment the comparator circuit 510 has a two-stage configuration, based upon a differential amplifier. A single stage amplifier, when driven through very low impedance, can be regarded as a single pole system, and therefore maintains a phase margin (PM) of 90° under a closed loop configuration. Therefore, the chosen topology allows not only for a remarkable gain, but for a simple offset compensation, when the offset of each stage is mitigated by closing a loop around a differential amplifier. Offset compensation is discussed in greater detail below under the heading, “Operation”.

Accordingly, in this embodiment the comparator circuit 510 includes first and second differential amplifiers 520 and 530. The input signal to the comparator circuit 510 is the signal from the output line 420 of the column charge amplifier 400 shown in FIG. 4. Through a first switch 512, the input signal from the output line 420 is connected to the first plate of a capacitor 514, which is also connected through a second switch 516 to a reference Ramp voltage. In this embodiment, the reference Ramp voltage is generated as a single continuous, monotonically increasing signal, thereby avoiding the need for the additional circuitry required for a step-wise reference generator.

In this embodiment, a second plate of the capacitor 514 is in electrical communication with an inverting (−) input of the first differential amplifier 520. The output of the first differential amplifier 520 is in communication with a first plate of a capacitor 524. In addition, through actuation of a switch 522, the output of the first differential amplifier 520 may be also placed into and out of electrical communication with its own inverting input, effectively closing a loop around the first differential amplifier 520.

Similarly, in this embodiment a second plate of the capacitor 524 is in electrical communication with an inverting (−) input of the second differential amplifier 530. The output of the second differential amplifier 530 is in communication with a step-down level shifter 540, which provides a digital domain trigger signal Trig<i> as discussed in greater detail below. In addition, through actuation of a switch 532, the output of the second differential amplifier 530 may be also placed into and out of electrical communication with its own inverting input (−), effectively closing a loop around the second differential amplifier 530.

In this embodiment, the non-inverting input (+) of the second differential amplifier 530 is in electrical communication via a switch 534 with the output line 420 of the column charge amplifier to receive its input signal therefrom, and is also in electrical communication via a switch 536 with the reference Ramp signal discussed earlier herein.

In this embodiment, the register circuit 600 includes a 10-bit register with parallel loading and serial scanning/unloading. More particularly, in this embodiment the register circuit 600 includes a 10-bits counter 602, which in this embodiment is synchronized with a clock signal CLK received on a clock line 604. In this embodiment, the register circuit 600 is also in communication with the step-down level shifter 540 which provides the digital trigger signal Trig<i>. When the latter trigger signal is received, it causes latching of the code generated by the 10-bits counter 602 into a column-wise 10-bit register 606. As discussed below, in successive cycles, the contents of the column-wise 10-bit register 606 are shifted one position to the right through successive column registers shown generally at 608, toward the output line 502 of the ADC block 500.

In this embodiment, the digitized output stream from the output line 502 is supplied to an off-chip Field Programmable Gate Array (not shown), from which it is transferred to a display screen.

In this embodiment, the column decoder 230 shown in FIG. 2 is also employed. The column decoder 230 effectively serves as a backup for the digital memory (counter and registers) of the register circuit 600, by multiplexing the various ADC signals onto a single output line 232, thus permitting the analog pixel output signals to be independently digitized off the chip 202 to obtain the final image. Alternatively, the column decoder 230 may be omitted if desired.

### Operation

In this embodiment, to capture an image frame from the image sensor 200, a first row of pixels of the pixels array 204 is selected and addressed via the row decoder and row logic block 210.

Next, the charge amplifiers block 400 is placed in a pixel-sampling configuration, while an active reset is performed at each pixel 102 of the currently selected pixel row, thereby establishing an initial DC level of the output 304 of the readout block 300.

To achieve the pixel-sampling configuration of the charge amplifiers block 400, a Sample signal that controls the sample switch 402 is pulsed high, thereby closing the switch 402 and placing the output line 304 (col. bus) of the readout block 300 in communication with the OTA 416 via the first selector circuit 405.

In this embodiment, the active reset of the currently addressed pixel row involves performing an active reset of the photodetector 104 of each pixel 102 of the currently selected pixel row of the image sensor 200 using the amplifier 302 which is also used for readout of the photodetector 104. Advantageously, in this embodiment a readout configuration of the amplifier 302 is maintained during the active reset.

In this embodiment, performing the active reset includes performing an asymmetrical active reset, which in this embodiment includes shorting the photodetector 104 across the amplifier 302. More particularly, in this embodiment shorting includes placing a photosensing element of the photodetector 104 or the photosensing node 106 of the photodetector 104 in simultaneous electrical communication with the first and second load lines 306 and 308 of the amplifier 302. In this embodiment, this is achieved by setting the active reset (SAR) signal received at the gate terminal of the reset transistor 133 high, thereby placing the photodetector 104 and its photosensing node 106 in simultaneous electrical communication with the both of the load lines 306 and 308 of the amplifier 302. Advantageously, therefore, in this embodiment the active reset is controlled using just a single, in-pixel reset transistor 133.

As noted above, in this embodiment the readout control circuit 120 advantageously maintains the readout configuration of the amplifier 302 during the active reset. In this embodiment, it will be recalled that the output line 304 of the amplifier 302 is connected to the gate terminal of the second in-pixel transistor 132, thereby forming a unity gain configuration of the amplifier 302. Thus, in this embodiment maintaining the readout configuration of the amplifier 302 during the active reset includes maintaining a unity gain configuration of the amplifier 302. More particularly, in this embodiment maintaining the unity gain configuration includes maintaining the output 304 of the amplifier 302 in electrical communication with the gate terminal of a switching element (in this case the second differential pair transistor 132), wherein the switching element has a source terminal in electrical communication with a current source load line (in this case the second load line 308) of the amplifier 302. More particularly still, in this embodiment the readout control circuit 120 includes the differential pair 130. One of the differential pair (the transistor 132) includes the switching element. The other of the differential pair (the transistor 131) has a gate terminal in electrical communication with the light flux-dependent node (in this embodiment the photodetector 104), and has a channel terminal in electrical communication with a second load line of the amplifier 302.

In this embodiment, in order to maintain the readout configuration of the amplifier 302 during the active reset, simultaneously with setting the active reset (SAR) signal high, the readout (RS) signal received at the gate terminal of the readout transistor 134 is also pulsed high, thereby placing the sink line 310 of the current source 370 in electrical communication with the second load line 308 of the amplifier 302.

Thus, during the asymmetrical active reset of the present embodiment, two closed loops exist simultaneously: a readout loop, and an active reset loop formed by activation of the reset transistor 133. In this embodiment, the reset voltage is set by the DC operating point of the formed active reset loop. As noted earlier, in this embodiment the active reset is controlled using only the reset transistor 133. Advantageously, this permits a reduction of both in-pixel and column-shared circuitry, as discussed earlier herein.

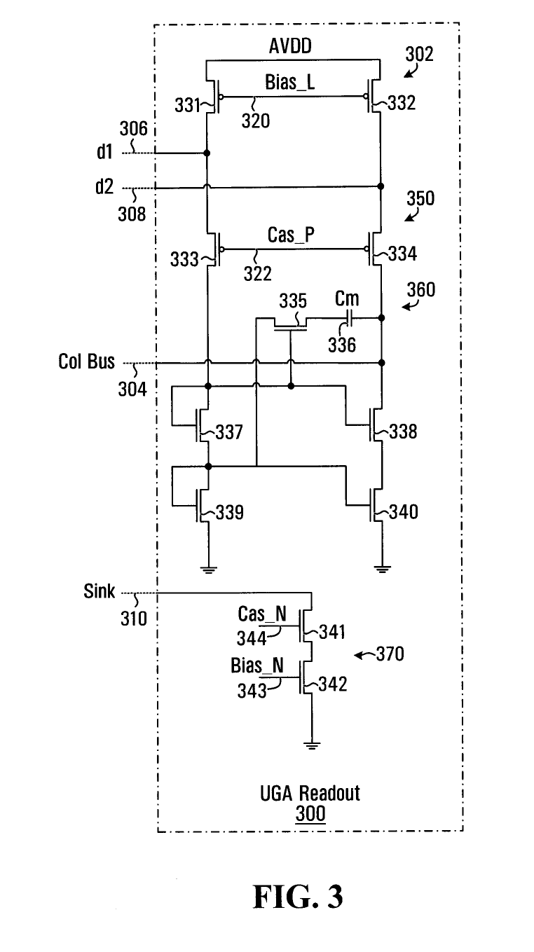

Referring to FIGS. 1 and 3, in this embodiment, with the transistors 133 and 134 both in their conducting states during the active reset, some current will flow from the transistor 331 of the amplifier 302, through the first load line 306, to the photodetector 104 and photosensing node 106, effectively charging the photodetector 104. Due to the maintained unity gain readout configuration of the amplifier 302, the output 304 of the readout block 300 (and hence the gate of the second in-pixel differential pair transistor 132) will closely follow the level of the photodetector 104 from this moment onward.

Referring to FIGS. 1-4, in this embodiment, as soon as the initial DC level of the output 304 of the amplifier has been established in the above manner, the column charge amplifiers block 400 is also reset. To achieve this, in this embodiment the reset signal (Reset_A) received at the reset switch 440 of the column charge amplifiers block 400 is pulsed high, thereby closing the switch 440 and thus placing the output 420 of the OTA 416 in electrical communication with the node 414 to which the inverting (−) input of the OTA 416 is connected. Consequently, node 414 converges to the common mode (CM) reference level which is supplied to the non-inverting (+) input of the OTA 416. It will be recalled that the Sample signal received at the switch 402 is still high so that the switch 402 is closed, and likewise one of the switches 408 and 412 will also be closed depending on whether the Bypass or Bypass_b signal is high. Consequently, closing the reset switch 440 and causing the node 414 to converge to the common mode reference level CM resets the input capacitance C_{SH} of the capacitor 404, as well as either the input capacitance C_{IN} of the main sampling capacitor 406 or the input capacitance C_{BP} of the bypass sampling capacitor 410, depending on which of the switches 408 and 412 is closed.

In this embodiment, the active reset (SAR) signal supplied to the reset transistor 133 of the pixel 102 is then set low, and shortly thereafter, the Reset_A signal supplied to the switch 440 of the column charge amplifiers block 400 is also set low, causing the switch 440 to open. This enables the incoming pixel signal received on the output line 304 of the readout block 300 to be amplified with a gain equal to the ratio of the input capacitance to the feedback capacitance, where the input capacitance is determined by which of the switches 408 and 412 of the first selector circuit 405 is closed, and the feedback capacitance is determined by which one or more of the capacitors 424, 426, 428 and 430 has been selected by closing its respective gain switch 432, 434, 436 or 438.

Next, when it is time to obtain a digital sample of the pixel signal, in this embodiment the Sample signal received at the switch 402 of the column charge amplifiers block 400 is pulsed low, thereby opening the switch 402 and temporarily disconnecting the column charge amplifiers block 400 from the output 304 of the readout block 300. This latches the final pixel level on the capacitor 404, and thus maintains the output 420 constant for the subsequent analog-to-digital conversion.

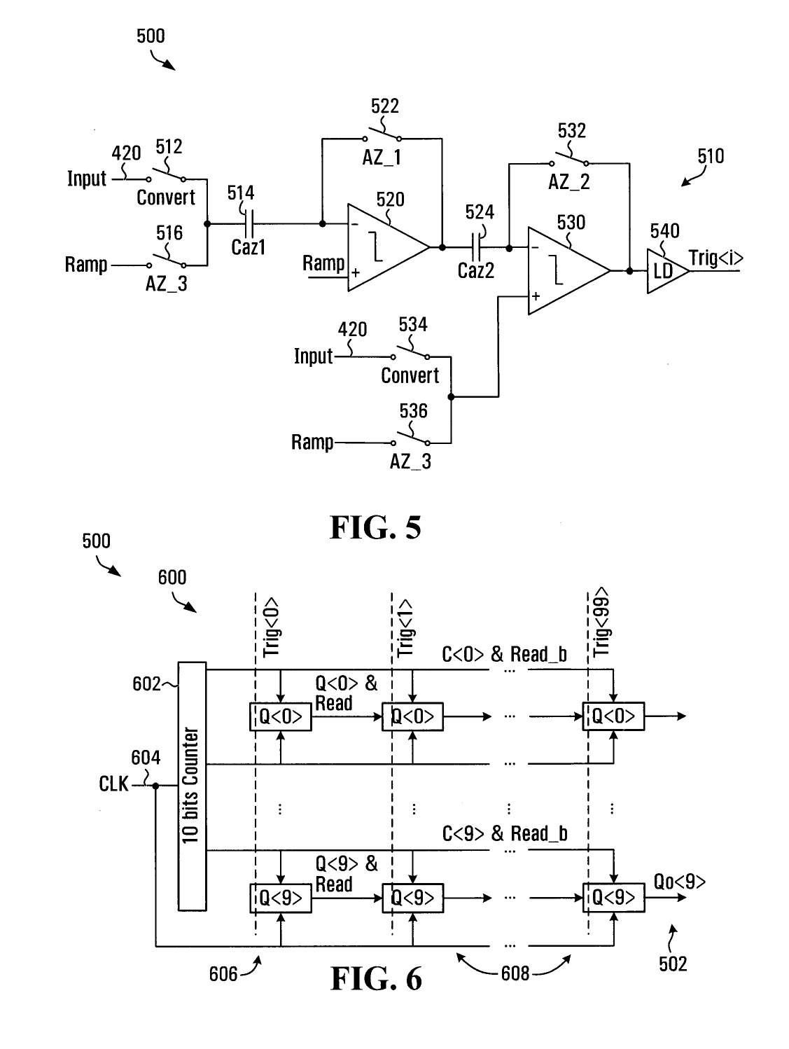

Referring to FIGS. 5 and 6, in this embodiment the analog-to-digital converter 500, or more particularly the comparator 510, performs offset cancellation, by closing a loop around a differential amplifier in order to mitigate the offset of each comparator stage. More particularly, in the present embodiment the offset cancellation is divided into three distinct phases. First, the signal Convert supplied to the switches 512 and 534 is set low and the signal AZ_3 supplied to the switches 516 and 536 is set high, thereby closing the switches 516 and 536 and connecting the reference Ramp voltage, which is constant at that moment, to a positive terminal of the capacitor 514, and to the non-inverting (+) input of the second stage amplifier 530. Second, the signals AZ_1 and AZ_2 supplied to the switches 522 and 532 are set high, to store the comparators' offsets on the Caz1 and Caz2 capacitors 514 and 524, respectively, respectively. Next, the AZ_1 signal supplied to the switch 522 is pulsed low, while the AZ_2 signal supplied to the switch 532 is still high, thereby storing on the capacitor 524 the offset caused by the charge injections from the first stage loop disconnection. Finally, the AZ_2 and AZ_3 signals supplied to the switches 516, 532 and 536 are set low, while the Convert signal supplied to the switches 512 and 534 is set high, preparing the two stage comparator for the subsequent conversion.

As noted earlier, in this embodiment the reference Ramp signal is generated as a single continuous, monotonically increasing signal. More particularly, in this embodiment the reference Ramp signal is initially maintained constant during offset cancellations, and thereafter starts climbing, spanning the amplified pixel level found on the output line 420 of the column charge amplifier which is in communication with the input switches 512 and 534 of the comparator 510. In this embodiment, as the reference Ramp signal value crosses the amplified pixel value, the two stages' comparator toggles and generates a negative pulse, which the step down level shifter 540 inverts and adjusts to generate a digital domain trigger signal Trig<i>. This digital domain trigger signal Trig<i> is received at the register circuit 600, and enables the latching of the code generated by the 10 bits counter 602 into the column-wise 10 bit register 606. In this regard, in the present embodiment, the code generation within the 10 bits counter 602 is synchronized to a clock signal CLK, and thus the 10 bits counter 602 directly measures elapsed time. The time required for the voltage of the reference Ramp signal to rise to the voltage of the pixel signal present on the output line 420, and thus cause the comparator circuit 510 to generate the Trig<i> signal, is proportional to the voltage of the pixel signal present on the output line 420. Thus, in this embodiment the 10 bit time value that is latched from the 10 bits counter 602 to the column-wise 10-bit register 606 in response to the Trig<i> trigger signal effectively represents an indirect digital measurement of the analog pixel signal voltage present on the output line 420. Accordingly, in this embodiment, the 10 bits counter 602 begins to count elapsed time values. In response to the Trig<i> trigger signal generated at the step-down level shifter 540, the 10-bit code currently stored in the 10 bits counter 602 is latched into the column-wise 10-bit register 606. The counter 602 continues to count until the end of its 10-bit counting cycle (2¹⁰ time increments from 0 to 1023), at which time the contents of the column-wide 10-bit register 606 and the current contents of the other column registers 608 are shifted one position toward the right in FIG. 6 toward the output bus 502. In the present embodiment, for parallel loading of a digital word, the signal Read is low, whereas its complementary phase Read_b is high. As the conversion is due, the phases are inverted forming a 10 bit shift register for the sequential scan of the digitized pixel values. Every counting cycle, the contents of each column register are shifted right towards the output bus 502, which effectively outputs a digital stream of column register data.

In this embodiment, the above steps are repeated as needed to obtain digital pixel data for the remaining pixels of the currently selected pixel row, and then for the pixels of all other pixels of the array 204 for each frame, and are likewise repeated to obtain successive frames. In this embodiment, the digital output stream on the output bus 502 is received at an off-chip Field Programmable Gate Array (FPGA) (not shown), which re-organizes the digital output stream and controls a video display device (not shown) to display the images represented by the digital output stream.

### Prototype Pixel and Simulations

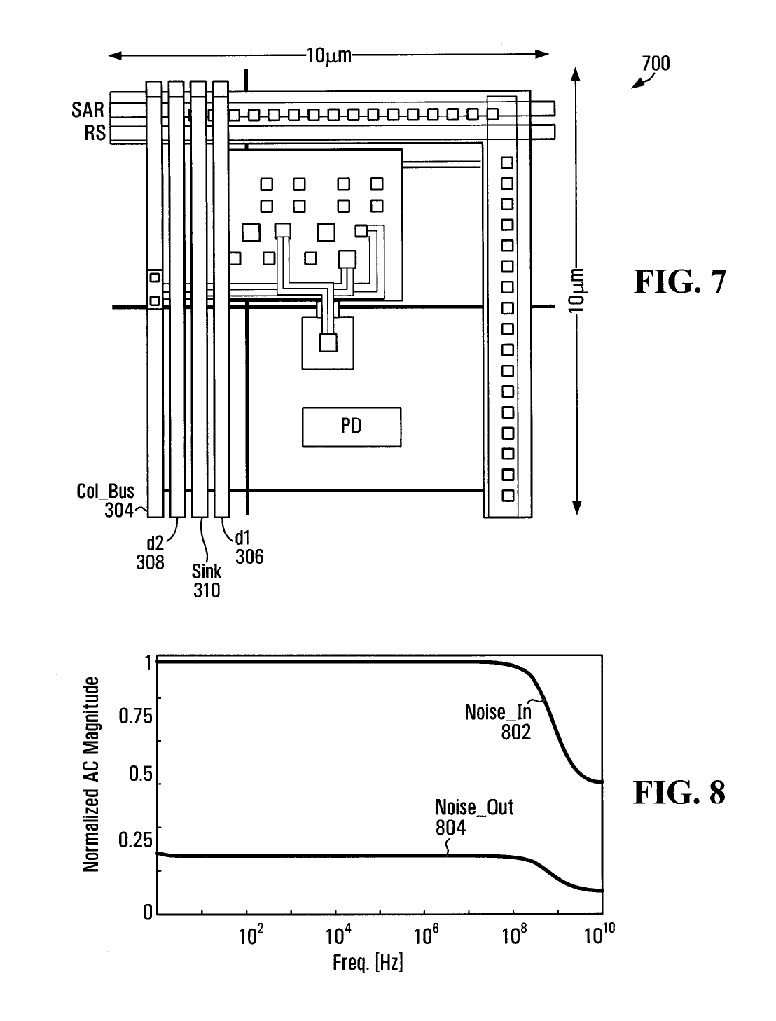

Referring to FIGS. 1 and 7, a prototype of the pixel 102 is shown generally at 700 in FIG. 7. The pixel 700 was implemented in TSMC018 1poly, 6 metals technology. The resulting pixel pitch was 10 μm with a photodiode PD area (Fill Factor) of 40%. To facilitate a proper operation, the analog lines, namely Col_Bus, d2, Sink, and d1 (corresponding to lines 304, 308, 310 and 306 respectively in FIG. 1) were laid perpendicularly to the digital lines SAR and RS (which respectively connect to the reset transistor 133 and the readout transistor 134 in FIG. 1). Furthermore, lines d1 and d2, implemented in the same metal, were placed on opposite sides of the shared source line Sink, achieving a better common noise rejection and an extended decoupling one from another. The other two analog lines were implemented in a different metal to minimize the coupling between the four lines.

The present inventors have also generated simulations of circuits similar to those discussed above, using Cadence™ circuit simulation software available from Cadence Design Systems, Inc. of San Jose, Calif., USA.

For example, referring to FIG. 8, it can be readily seen that the active reset has significantly decreased the KTC or reset noise: the initially injected input noise 802 appears to be roughly five times greater than the resulting simulated output noise 804.

A simulation also showed that, following commencement of the active reset by setting the SAR signal high, once a self-biased reset level around 2.2V had been set, the pixel output on the Col_Bus output line 304 closely followed the discharge of the photodetector 104, with the difference between the two signals remaining under 20 μV across a wide voltage swing from 2.2V to 1.1V. Below 1.1V the folded cascode amplifier 302 leaves its saturation region, causing the output line 304 to diverge from the photodetector 104. The readout precision achieved in the simulation allows for detection of a single electron, which substantially surpasses the sensitivity of a conventional source follower.

### Alternatives:

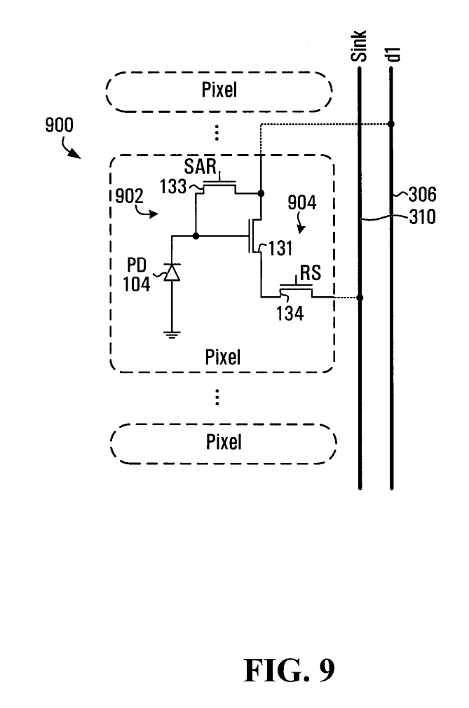

Referring to FIGS. 1, 9 and 10, a pixel according to a second embodiment of the invention is shown generally at 900 in FIG. 9. The pixel 900 is similar in some ways to the pixel 102: for example, like the pixel 102, in this embodiment the pixel 900 also includes an active reset control circuit 902 configured to perform an active reset of a light flux-dependent node (specifically the photodetector 104) of the pixel 900 using an amplifier 1000 which is also used for readout of the photodetector 104, and further includes a readout control circuit 904 configured to maintain a readout configuration of the amplifier 1000 during the active reset. Thus, in this embodiment the active reset control circuit 902 includes the reset transistor 133 of the pixel 102, and the readout control circuit 904 includes the readout transistor 134 and the differential pair transistor 131 of the pixel 102, although the location of the readout transistor 134 is changed in the pixel 900.

In this embodiment, however, the pixel 900 has been considerably simplified. The second transistor 132 of the differential pair 130 has been removed from the pixel 900, effectively moving it to the column periphery as discussed below. In view of this change, corresponding changes have been made to the readout amplifier 1000. Previously, the readout transistor 134 of the pixel 102 separated the differential pair 130 comprising both transistors 131 and 132 from the sink line 310. In the pixel 900, however, the readout transistor 134 separates only the transistor 131 from the sink line. Consequently, to maintain a similar signal path, in this embodiment a switch is added at the column periphery to equalize the voltage drop in the complementary branches of the readout amplifier.

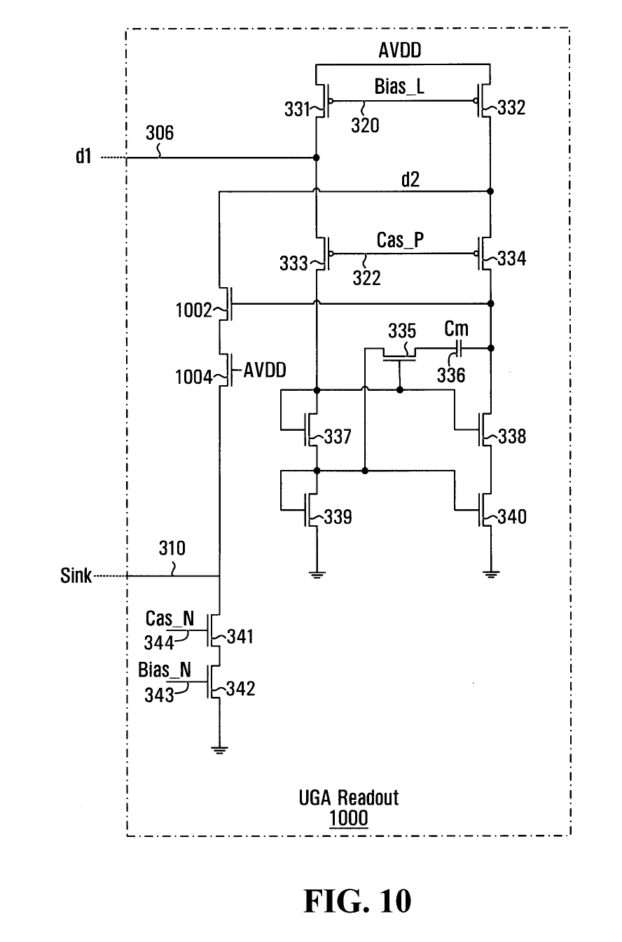

Thus, referring to FIGS. 3 and 10, in this embodiment the amplifier 1000 differs from the amplifier 302, insofar as transistors 1002 and 1004 have been added. Transistor 1002 effectively completes the differential pair to replace the removed transistor 132, while transistor 1004 compensates for the above-noted voltage drop.

Accordingly, in this embodiment the readout control circuit 120 includes a first transistor (in this case the transistor 131) having a gate terminal in electrical communication with the light flux-dependent node (which in this embodiment includes the photodetector 104) and having a first channel terminal in electrical communication with the first load line 306 of the amplifier 302, and a readout transistor (in this case the transistor 134) configured to conduct between a second channel terminal of the first transistor 131 and a sink line 310 of the amplifier 302 in response to a readout signal received at a gate terminal of the readout transistor 134.

Also in this embodiment, the active reset control circuit 110 includes the reset transistor 133, which in this embodiment is configured to place the light flux-dependent node (in this embodiment the photodetector 104) in simultaneous electrical communication with a sink line and a load line of the amplifier. More generally, in this embodiment the pixel 900 consists essentially of the three transistors 131, 133 and 134 plus the photodetector 104. Not only has the transistor 132 been removed from the pixel, but two bias lines (the output line Col. Bus. And the load line d2) have also been removed. The reset transistor is configured slightly differently than in FIG. 1, to form the reset loop by simultaneously connecting the photodetector 104 to the sink line 310 and the first load line 306, rather than shorting it across both load lines 306 and 308. Advantageously, therefore, the present embodiment provides active reset in a “3T” pixel having only three transistors and two bias lines (Sink and d1). Consequently, the fill factor of the pixel 900 is considerably higher than that of the pixel 102. More particularly, in embodiments of the pixel 900 it is expected that a fill factor (FF) in excess of 75% can be achieved with careful packaging.

Although the embodiments described above employed unity gain amplification (UGA) in the readout block 300, alternatively, embodiments of the present invention may be employed in single ended or in open loop readout schemes, for example. By using in-pixel amplification, higher sensitivity can be achieved while at the same time reducing the column processing circuitry.

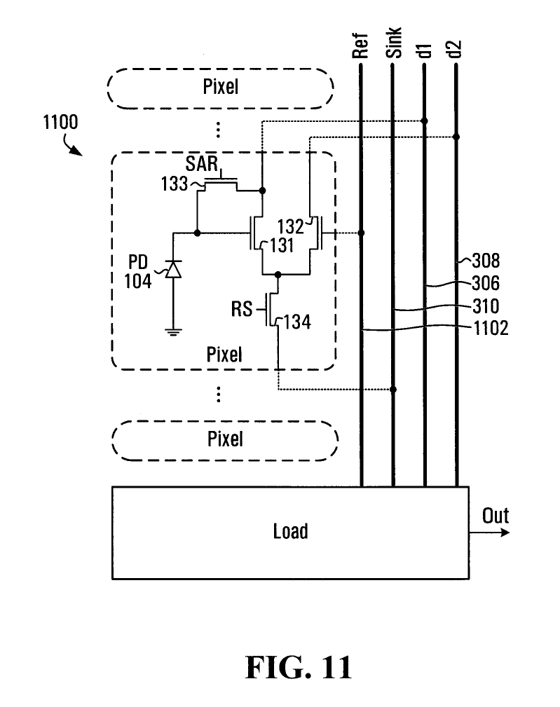

For example, referring to FIGS. 1 and 11, a modified “4T” (four-transistor) pixel employing a single ended open loop amplification scheme is shown generally at 1100 in FIG. 11. To modify the pixel 102 to form the pixel 1100, instead of closing a readout loop through an amplifier output line Col_Bus, a common reference signal (Ref) line 1102 is provided and is placed in electrical communication with the gate terminal of the transistor 132, and the amplified signal Out is obtained from the column shared load line.

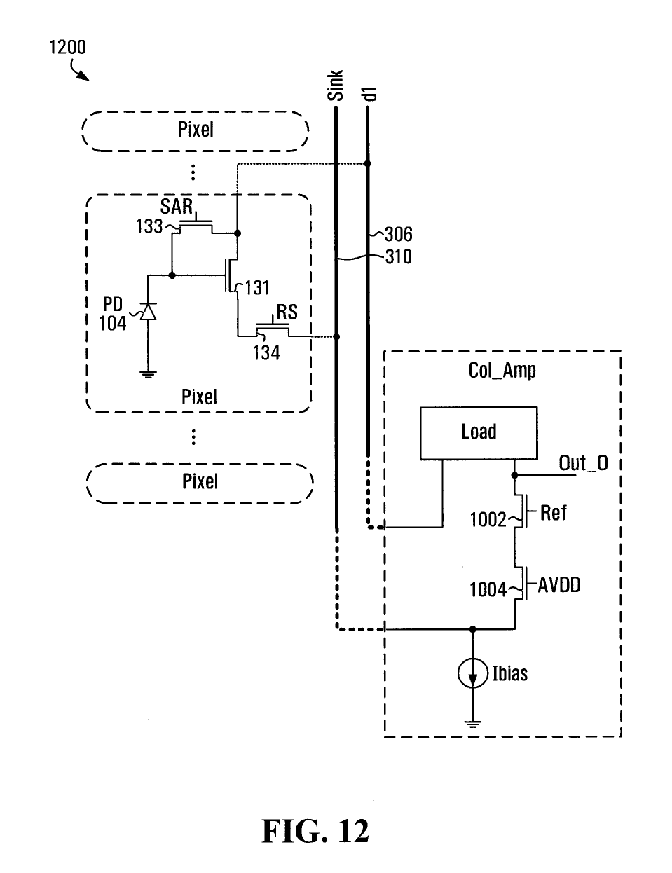

Similarly, referring to FIGS. 9, 10, and 12, the “3T” pixel 902 of FIG. 9 may similarly be modified for non-unity gain readout to form a pixel 1200 employing a single ended open loop amplification scheme. In this embodiment, the transistors 1002 and 1004, found within the column shared amplifier Col_Amp, complete the differential pair, resembling the configuration of FIG. 10. The output Out_O provides the amplified signal.

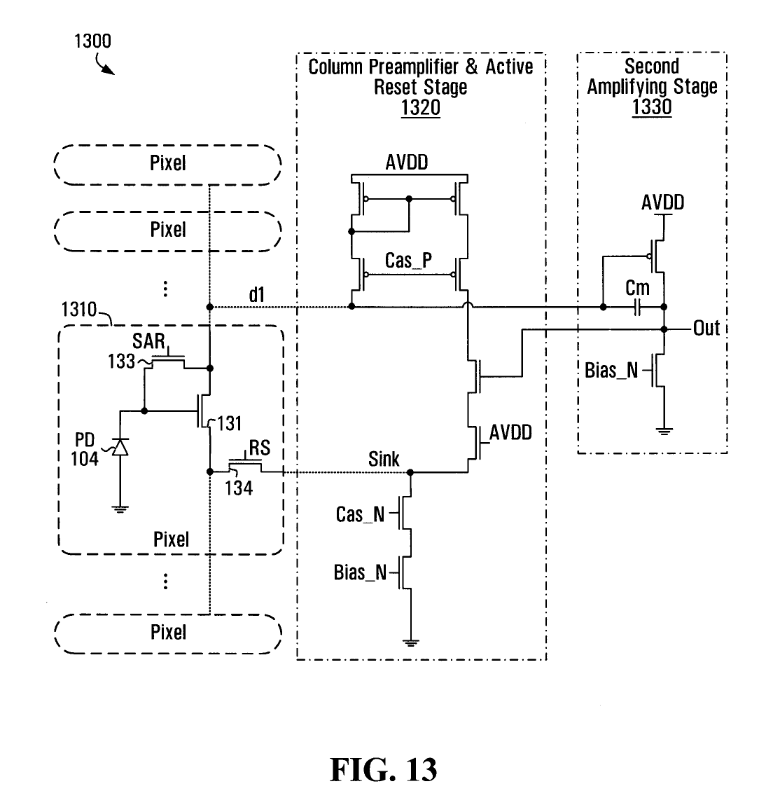

Referring to FIGS. 9 and 13, a multi-stage amplification scheme is shown generally at 1300 in FIG. 13. In this embodiment, a modified 3T pixel 1310 similar to the pixel 902 is shown in conjunction with a two-stage amplifier, which in this embodiment includes a column preamplifier and active reset stage 1320, and a second amplifying stage 1330.

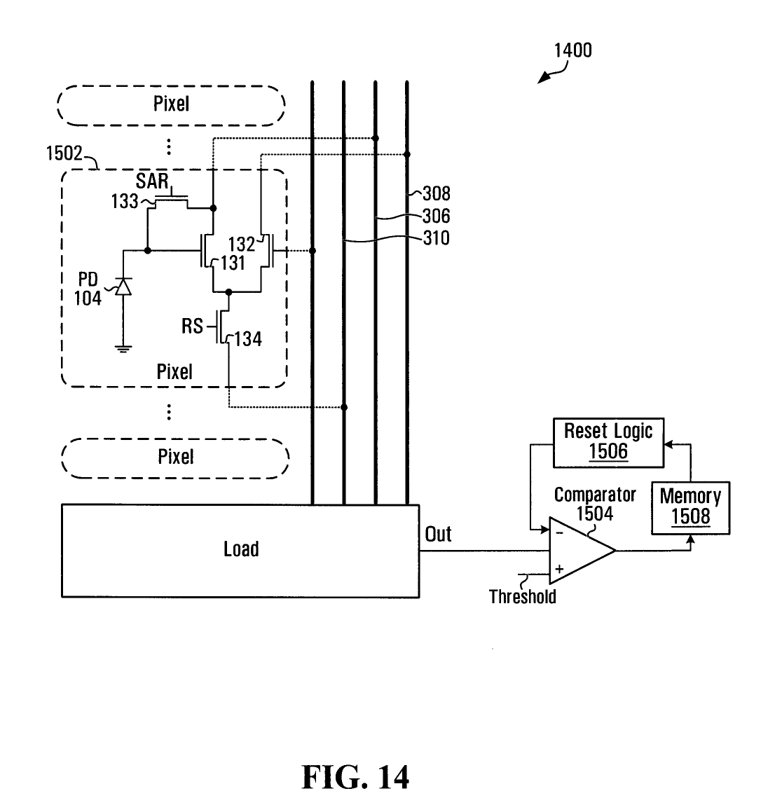

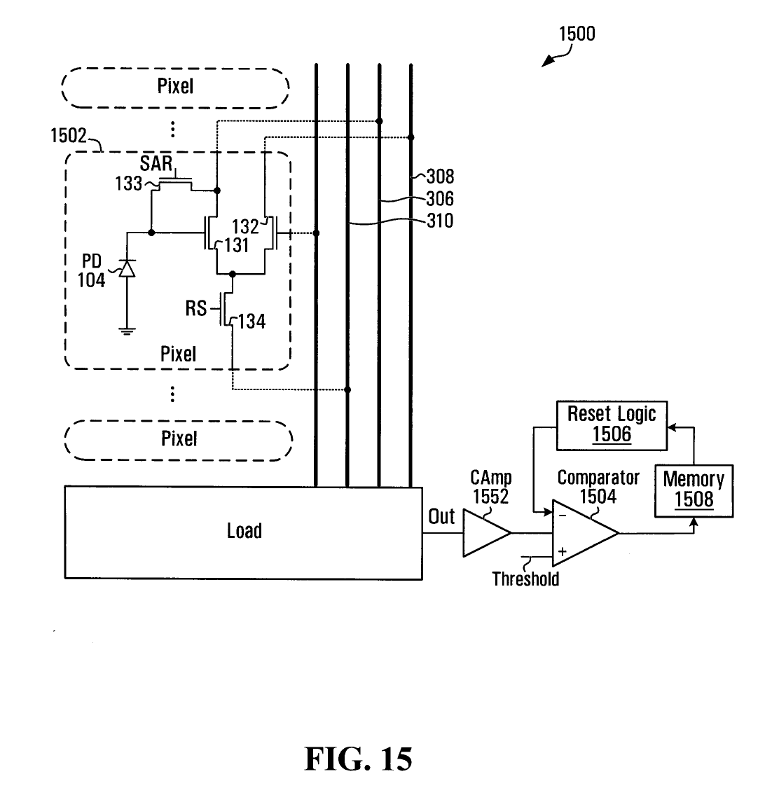

Referring to FIGS. 14 and 15, two illustrative Wide Dynamic Range (WDR) configurations are respectively shown at 1400 in FIG. 14 and at 1500 in FIG. 15.

In the first WDR configuration 1400 shown in FIG. 14, a typical WDR implementation is applied to a novel 4T pixel 1502 similar to the pixel 102, whereby the pixel is sampled through Active Column Sensing throughout the integration, and the pixel level Out signal is then fed to a Comparator 1504. The comparator 1504 is paired with Reset Logic 1506 to generate the next WDR bit, which is written into a memory 1508.

In the second WDR configuration 1500 shown in FIG. 15, a ranging procedure is employed, whereby the pixel 1502 is allowed to integrate for a short period of time to assess the light intensity it receives before the main integration starts. To achieve this, in this embodiment a charge amplifier 1552 is inserted between the pixel out signal and the comparator 1504. This way, the WDR extension bits are set prior to the main integration and the pixel is reset according to the information stored inside the Memory 1508, advantageously omitting multiple write memory operations that would have been required with the more typical WDR implementation discussed in connection with FIG. 14.

In this embodiment, the charge amplifier 1552 is similar to the column charge amplifiers block 400 shown in FIG. 4, apart from the feedback capacitors, which have to be scaled differently than the feedback capacitors 432, 434, 436 and 438 of FIG. 4. More particularly, the feedback capacitors of the charge amplifier 1552 are scaled according to the 0.5ⁱ ratio to the input capacitance, i.e. 0.5, 0.25, 0.125, etc., resulting in 2ⁱ amplification. In this embodiment, after the pixel finishes the short integration, its signal is amplified by gradually increasing gains and is compared to the threshold voltage of the comparator 1504. Upon crossing it, for the first time the WDR information is generated and written into the memory 1508.

Further variations of the second WDR configuration 1550 are also contemplated. For example, the threshold can be varied, leaving the gain constant. Alternatively, the gains and the threshold can be varied in a certain sequence to decrease the Threshold voltage precision requirements, for example.

Although the embodiments described above have pertained to active reset of a photodetector, alternatively, the improved active reset methods described herein may alternatively be applied to any other light flux-dependent node of the pixel, i.e. a node whose measurable property (such as voltage for example) depends upon the light flux received at the pixel, such as a sampling node, for example. Similarly, although the embodiments above involved placing the photodetector in simultaneous electrical communication with first and second lines of specific amplifiers, more generally the photodetector (or other pixel node to be actively reset) may be actively reset using any internal amplifier node(s) that can form a negative feedback to the photodetector (or other pixel node).

Similarly, although the embodiments described above have involved measuring the photodetector's voltage and using feedback to actively reset the photodetector's voltage, alternatively, other embodiments may involve measuring other light-dependent properties, such as current.

In addition to the embodiments described above, it is contemplated that any one or more features of any particular embodiment may be combined with any one or more features of any other embodiment, except where such features have been described as mutually exclusive alternatives.

More generally, while specific embodiments of the invention have been described and illustrated, such embodiments should be considered illustrative of the invention only and not as limiting the invention as defined by the accompanying claims.

What is claimed is:

1. A method of controlling an image sensor, the method comprising:
performing an active reset of a light flux-dependent node of a pixel of the image sensor using an amplifier which is also used for readout of the light flux-dependent node; and
maintaining a readout configuration of the amplifier during the active reset.

2. The method of claim 1 wherein performing the active reset comprises placing the light flux-dependent node in electrical communication with an internal node of the amplifier to form a negative feedback to the light flux-dependent node.

3. The method of claim 2 wherein the light flux-dependent node comprises a photodetector and wherein placing comprises shorting the photodetector across first and second load lines of the amplifier.

4. The method of claim 1 further comprising maintaining the readout configuration while performing a readout of the pixel.

5. The method of claim 1 wherein maintaining the readout configuration comprises maintaining a unity gain configuration of the amplifier.

6. The method of claim 5 wherein maintaining the unity gain configuration comprises maintaining an output of the amplifier in electrical communication with a gate terminal of a switching element, wherein the switching element has a source terminal in electrical communication with a current source load line of the amplifier.

7. The method of claim 1 wherein maintaining the readout configuration comprises maintaining the readout configuration of an amplifier located at least partly outside the pixel.

8. A control circuit for an image sensor, the control circuit comprising:
an active reset control circuit configured to perform an active reset of a light flux-dependent node of a pixel of the image sensor using an amplifier which is also used for readout of the light flux-dependent node; and
a readout control circuit configured to maintain a readout configuration of the amplifier during the active reset.

9. The circuit of claim 8 wherein the active reset control circuit comprises a switching element configured to place the light flux-dependent node in electrical communication with an internal node of the amplifier to form a negative feedback to the light flux-dependent node.

10. The circuit of claim 9 further comprising the light flux-dependent node, wherein the light flux-dependent node comprises a photodetector, and wherein the active reset control circuit comprises an asymmetrical active reset control circuit configured to short the photodetector across first and second load lines of the amplifier.

11. The circuit of claim 8 wherein the readout control circuit is further configured to maintain the readout configuration while performing a readout of the pixel.

12. The circuit of claim 8 wherein the readout control circuit is configured to maintain the readout configuration by maintaining a unity gain configuration of the amplifier.

13. The circuit of claim 12 wherein the readout control circuit is configured to maintain an output of the amplifier in electrical communication with a gate terminal of a switching element, wherein the switching element has a source terminal in electrical communication with a current source load line of the amplifier.

14. The circuit of claim 13 wherein the readout control circuit comprises a differential pair of transistors, wherein one of the differential pair comprises the switching element, and wherein the other of the differential pair has a gate terminal in electrical communication with the light flux-dependent node and a channel terminal in electrical communication with a second load line of the amplifier.

15. The circuit of claim 14 wherein the readout control circuit further comprises a readout transistor having a first channel terminal in communication with channel terminals of the differential pair and having a second channel terminal in communication with a shared source line.

16. The circuit of claim 8 wherein the readout control circuit comprises:
a first transistor having a gate terminal in electrical communication with the light flux-dependent node and having a first channel terminal in electrical communication with a load line of the amplifier; and
a readout transistor configured to conduct between a second channel terminal of the first transistor and a sink line of the amplifier in response to a readout signal received at a gate terminal of the readout transistor.

17. The circuit of claim 16 wherein the light flux-dependent node comprises a photodetector and wherein the active reset control circuit comprises a reset transistor configured to place the photodetector in simultaneous electrical communication with a sink line and a load line of the amplifier.

18. The circuit of claim 8 further comprising the amplifier, wherein the amplifier is located at least partly outside the pixel.

19. The circuit of claim 8 further comprising the amplifier, wherein the amplifier comprises a folded cascode amplifier.

20. An image sensor pixel comprising the circuit of claim 8, wherein the pixel comprises no more than four transistors.

21. An image sensor pixel comprising the circuit of claim 8, wherein the pixel comprises no more than three transistors.

22. A Complementary Metal Oxide Semiconductor (CMOS) image sensor comprising a plurality of pixels, each of the pixels comprising the control circuit of claim 8.
